(19) United States
(12) Patent Application Publication
(10) Pub. No.: US 2004/0034873 A1
(43) Pub. Date: Feb. 19, 2004

(54) Event driven interactive television notification

(76) Inventor: Ian Zenoni, Highlands Ranch, CO (US)

Correspondence Address: The Law Offices of William W. Cochran, LLC, Suite 230, 3555 Stanford Road, Fort Collins, CO, 80525, US

(21) Appl. No.: 10/408,664

(22) Filed: Apr. 4, 2003

Related U.S. Application Data
(60) Provisional application No. 60/370,039, filed on Apr. 4, 2002.

(51) Int. Cl. H04N 7/173; H04N 7/16; H04N 7/00; H04N 11/00

(52) U.S. Cl. 725/135; 725/136; 725/105; 725/131; 725/120; 348/461

(57) ABSTRACT

Disclosed is a method and system that displays notifications to a user on a television system. The notifications comprise recent events occurring in subjects of importance to the user. The user may view data and video clips of the recent event, web pages, enhanced web pages, and alternate channels. Access is provided through the Internet, to enhanced web pages designed specifically for television, and regular web pages. Users can switch from the current broadcast to another channel, such as the channel displaying the recent event.

### CROSS REFERENCE TO RELATED APPLICATIONS

The present application is based upon and claims the benefit of U.S. Provisional Patent Application Serial No. 60/370,039, entitled “EVENT DRIVEN INTERACTIVE TELEVISION NOTIFICATION,” filed Apr. 4, 2002 by Ian Zenoni, the entire contents of which is hereby specifically incorporated by reference for all it discloses and teaches.

### BACKGROUND OF THE INVENTION

a. Field of the Invention

The present invention pertains generally to interactive television and more particularly to event notification provided by interactive television.

b. Description of the Background

Currently, a user may receive up-to-date, current information on subjects that are of interest to the user such as stock updates, travel, health, weather, sports, etc. The user may obtain up-to-date information by having notifications sent to the user's personal computer (PC). Upon receiving notification on a PC, the user may click on the notification and gain access to a web page. This type of technology is currently provided by web sites such as MSNBC wherein the user may submit stock, travel, and/or weather preferences, and receive current information on these topics. However, there is no provision for allowing a user to view current, up-to-date notifications via a television system.

A need therefore exists for a television-based interactive notification system. In that regard, a need exists for users to be able to receive updated information, based on the occurrence of events, on a television system in the same way that users receive updated information from a PC.

### SUMMARY OF THE INVENTION

The present invention overcomes the disadvantages and limitations of the prior art by providing a system and method in which an interactive television system can be used to provide users with current, up-to-date information that is relevant to the user.

The present invention may therefore comprise a method of providing event information to a user on a television comprising receiving event information, including event data and event video, at an event notification server located at an upstream source, the event information generated by a content provider; transmitting the event data to an event data database for storage and retrieval of the event data; transmitting the event video to event video storage for storage and retrieval of the event video; receiving user preferences from a set-top box at the event notification server via an upstream connection between said set-top box and the event notification server; transmitting the user preferences to a user preference database for storage and retrieval of the user preferences; comparing the event data with the user preferences at the event notification server; generating an event notification trigger upon favorable comparison of the user preferences and the event data, the event notification trigger including an address of the set-top box; transmitting the event notification trigger to the address of the set-top box; generating a graphic user interface on the television, using the set-top box, in response to the event notification trigger, the graphic user interface allowing the user to select at least one of: downloading the event video from the event video storage for display on the television; accessing an Internet location that provides the event information on the television; switching the television to an alternate channel that is displaying the event information, and exiting the graphic user interface.

The present invention may further comprise a system for providing event driven notifications to a user and displaying event information on a television comprising: an event notification server, located at an upstream source, that receives event video and event data from the content provider; an event video storage device that receives the event video from the event notification server and that stores the video associated with the event data; an event data database that receives the event data from the event notification server and that stores the event data; a user preference database that receives preferences from the user and stores the preferences; a comparator that compares user preferences to the event data, and that generates an event notification trigger having an address for transmitting the event notification trigger to the user; an event notification trigger inserter that inserts the event notification trigger into a television transmission signal that is transmitted through a downstream connection to the user; a set-top box that receives preferences provided by the user and transmits the preferences through an upstream connection to the user preference database, and that receives the event notification trigger from the event notification server via the downstream connection and generates a graphic user interface for display on the television that allows the user to select at least one of: downloading the event video for display from the event video storage device through the downstream connection; accessing an Internet location that provides the event information; switching to an alternate channel displaying the event information; and, exiting the graphic user interface.

Advantages of the present invention include, but not by way of limitation, the ability to provide notifications to a user, that are of importance and/or interest to the user, on an interactive television system. The present invention may allow the user to view notifications in the form of visual data, such as video clips and enhanced web pages, as well as audio information. The present invention may provide access, through the Internet, to enhanced web pages designed specifically for television, and regular web pages. The present invention may allow the user to switch from the current broadcast to another channel, such as the channel displaying the recent event.

### BRIEF DESCRIPTION OF THE DRAWINGS

FIG. 1 is a block diagram of one implementation of the present invention.

FIG. 2 is a graphical illustration of the display of event data.

FIG. 3 is a block diagram illustrating access of a set-top box by an event notification server.

FIG. 4 is a graphical representation of one embodiment of an event notification trigger.

FIG. 5 is a flow diagram illustrating the steps performed by an upstream source in carrying out an implementation of the present invention.

FIG. 6 is a flow diagram illustrating the steps performed by the set-top box in carrying out an implementation of the present invention.

FIG. 7 is a flow diagram illustrating the steps 800 performed by the content provider for sending trigger information to the event notification server.

### DETAILED DESCRIPTION OF THE INVENTION

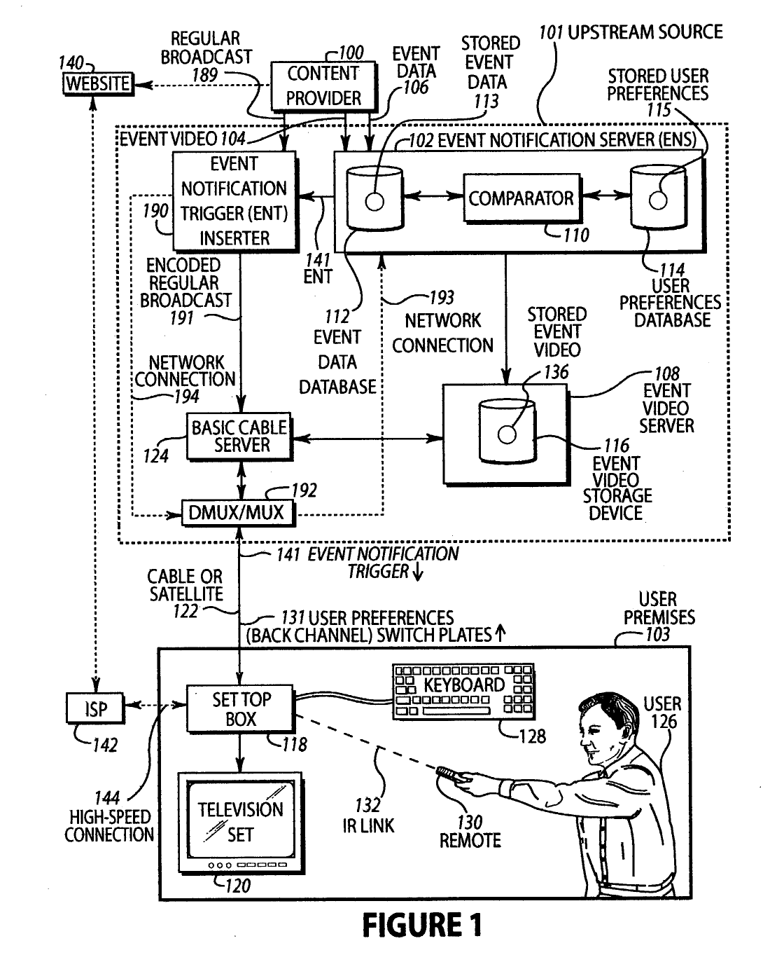

FIG. 1 is a block diagram of one implementation of the present invention. Referring to FIG. 1, a user 126 may be provided current, up-to-date information that is relevant to the user 126. The present invention may provide notifications to the user 126 regarding current events, such as weather, sports and news, that are relevant to the user 126. This may be done by providing the user 126 access, through an interactive television 120 and a graphical user interface (GUI), to links to web pages, enhanced web pages, and other links. Links may comprise links to stored video, links to enhancements, or links to a different television channel.

As shown in FIG. 1, a content provider 100 is coupled to an event notification server (ENS) 102 located at an upstream source, such as a head-end location 101. Content provider 100 sends a regular broadcast video signal 189, as well as event video 104 and event data 106, to a head-end 101. The regular broadcast video 104 is transmitted from the upstream source 101 to at least one set-top box 118. Event video 104 may comprise streaming video, stored video, video clips, enhanced video, or other video. Event video 104 is periodically updated, or updated on an event driven basis, by the content provider 100 and is sent to the ENS 102. The content provider 100 may comprise any content provider that provides content such as a television network, television studio, a live broadcast, a server providing data such as an Applications Service Provider, an Internet Service Provider, or any other type of content provider that may be capable of sending content to viewers. Television networks may comprise ESPN, FOX, MSNBC, the Weather Channel, or other networks that provide sports, news and weather information. By providing video clips versus purely textual information, the user may enjoy a much more compelling and informative interactive experience. Event data 106 can also be fed directly from various sources such as directly from the New York Stock Exchange, the National Weather Service, or other content providers. In fact, any type of content provider can provide data for use in accordance with the present invention. Direct data feeds may be provided by channels such as ESPN. ESPN periodically updates and creates specialized video clips such as sports clips, news clips, etc.

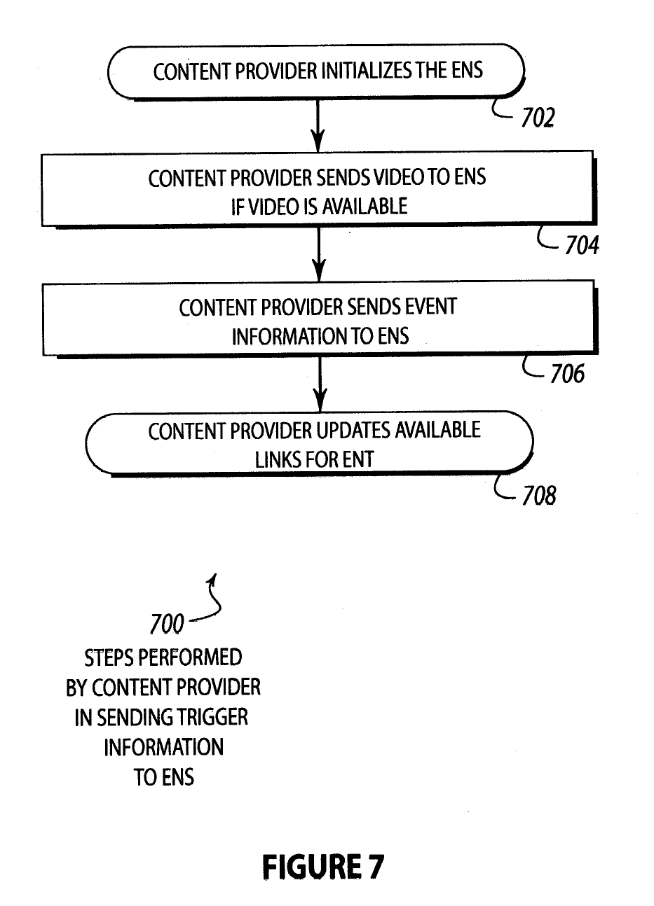

Turning again to FIG. 1, ENS 102 may comprise a server having a processor (not shown), I/O functions and various storage capabilities. Event data 106 may comprise streaming (real-time) data such as stock values, weather information, news information, etc. Event video server 108 may also be located at the head-end 101. Event video server 108 receives event video 104 from ENS 102 and stores the event video 104 in an event video storage device 116. Event video server 108 may also include a processor (not shown), I/O functionality, etc. The event video storage device 116 may comprise a video on-demand system which is capable of storing and retrieving video segments, or any other type of video storage and retrieval system. The event video server 108 may receive specialized video segments 104 from the ENS 102. The event video storage device 116 of event video server 108 stores video segments 104 as stored event video 136. Event video segments 104 (video clips/video hi-lights) may be created by the content provider 100, as is further discussed below with regard to the description of FIG. 7. Once the ENS 102 receives the event video 104 and event data 106 (collectively referred to as event information) from the content provider 100, the ENS 102 may associate the event data 106 to the corresponding event video 104. The ENS 102 may further include a comparator 110.

Referring again to FIG. 1, the ENS 102 receives user preferences 131 from a user 126. The user preferences 131 may be transmitted from a set-top box 118 that is connected to television set 120, or any other desired method of transmitting the user preferences to ENS 102, including Internet connections, dialup transmissions, etc. If the user 126 transmits user preferences 131 to set-top box 118, the ENS 102 may receive user preferences 131 over cable 122 via a back channel using a cable modem, or an asymmetrical connection such as a high speed telephone line (DSL), a modem (56k), and LAN connection (Ethernet). Cable connection 122 can also comprise a satellite connection. Cable 122 serves set top box 118 from a basic cable server (basic cable provider) 124. Set top box 118 may receive regular broadcast television 189 from basic cable server 124. Cable 122 may comprise a cable or satellite connection to the set-top box and may include multiple frequency channels. One set of frequencies may comprise regular broadcast video signal 189, and at least one other frequency may comprise an out-of-band channel, a back channel, or other channel (collectively referred to as a back channel) that is accessible by the set-top box 118. The out-of-band channel may be used to transmit current (real-time) programming guide information or other information including event video 104.

As indicated above, user preferences 131 may be entered into the set-top box 118 by a user 126 at the user premises 103. The user 126 may enter user preferences 131 by several methods, including keyboard 128, remote control device 130 and wireless link 132, such as an infrared link, a radio frequency link, or other link, or by any device capable of transmitting information. The user 126 may update user preferences 131 at any time, and the user preferences 131 may be accessed and retrieved by the ENS 102 at any time during the interaction between the user and the system illustrated in FIG. 1. The content provider 100 may provide a template to user 126 for the user 126 to fill in. The template may be in the form of a graphical user interface. In this way, the content provider 100 may present optional events for the user 126 to select. The events may include certain sports games, stocks, weather, etc. The user 126 may also be asked to submit thresholds for the events, as explained below. Collection, storage and retrieval of user preferences can be accomplished as disclosed in U.S. Non-Provisional application Ser. No. 09/933,928, entitled “iSELECT VIDEO,” filed Aug. 21, 2001 by Steven Peliotis, Steven O. Markel, Ian Zenoni & Thomas Lemmons; U.S. Non-Provisional application Ser. No. 09/941,148, entitled “PERSONALIZED REMOTE CONTROL,” filed Aug. 27, 2001 by Thomas Huber, Steven O. Markel, Ian Zenoni and Thomas Huber; U.S. Non-Provisional application Ser. No. 10/076,950, entitled “VIDEO TAGS & MARKERS,” filed Feb. 12, 2002 by Ian Zenoni; U.S. Non-Provisional application Ser. No. 10/046,618, entitled “COLLECTION OF AFFINITY DATA FROM TELEVISION, VIDEO OR SIMILAR TRANSMISSIONS,” filed Oct. 26, 2001 by Steven O. Markel, Ian Zenoni and Thomas Lemmons; and U.S. Non-Provisional application Ser. No. 10/099,054, entitled “AFFINITY MARKETING FOR INTERACTIVE MEDIA SYSTEMS,” filed Mar. 13, 2002 by Steven O. Markel, all of which are specifically incorporated herein by reference for all that they disclose and teach.

User preferences 131 may comprise a user's video choices, a user's thresholds (limits for changes) within stock information, sports scores, or other user preferences 131. The user preferences 131 may comprise specific events which the user 126 wishes to view. The user 126 may specify that whenever an “event” occurs, the user 126 receives notification. The term “event” can include some occurrence that exceeds the limits of thresholds set within user preferences 131 by a user 126. The term “threshold” refers to factors which determine the frequency, severity, etc. of an event which may result in notifications being sent to the user 126. The frequency at which an event may be viewed may be determined by threshold data entered by the user 126. For example, the user 126 may wish to view the user's stocks as the stocks change by a threshold of $3.00 per share or if the volume of sales exceeds a set threshold. If user 126 is watching a regular broadcast of FOX news on the user's television set 120, and the values or volume of sales of stocks of particular interest to the user 126 (which have been input by the user 126 into the user's set-top box 118) exceed a threshold, either positively or negatively, the user 126 may be presented with a GUI that allows the user 126 to view particular data about that stock. Again, the viewer may view an enhanced television web page, an independent video clip, or the channel currently broadcasting the change in stock price or volume. The set-top box 118 may change from the regular broadcast to an alternative video source in order to provide the user 126 with a specific video clip. The user 126 may be able to access sports and weather information in the same manner. For example, the user 126 may select, as a threshold, to view football scoring events with a change in score of at least 5 points. The user 126 may receive notification when the football score has recently changed by 5 points, activate the notification, and view the last play that caused the score to change in that particular sports game. Alternatively, the user 126 may wish to view weather alerts by selecting a threshold of storms labeled as “severe.”Events and thresholds may also be defined and provided by the content provider or by the user 126.

Looking again to FIG. 1, user preferences 131 are sent, over the back channel of cable 122, from the set-top box 118 to a de-multiplexer/multiplexer (DMUX/MUX) 192. DMUX 192 separates video from the user preferences data 131. The user preferences 131 are then sent to the user preferences database 114 located in the ENS 102. User preferences 131 are sent to the user preferences database 114 via network connection 193. Network connection 193 may comprise an Ethernet connection or any desired type of network connection in ENS 102.

As also shown in FIG. 1, the comparator 110, which may comprise a programmed function of the process of ENS 102, accesses stored user preferences 115 from the user preferences database 114. The comparator 110 then compares the stored user preferences 115, in the user preferences database 114, with stored event data 113, in the event data database 112. If no match is made between the stored event data 113 and the stored user preferences 115, then the ENS 102 may continue to make comparisons until a comparison/match is made between the updated stored event data 113 and the stored user preferences 115. Concurrently (while the comparator 110 makes comparisons), real time event data 106 is received from the content provider 100.

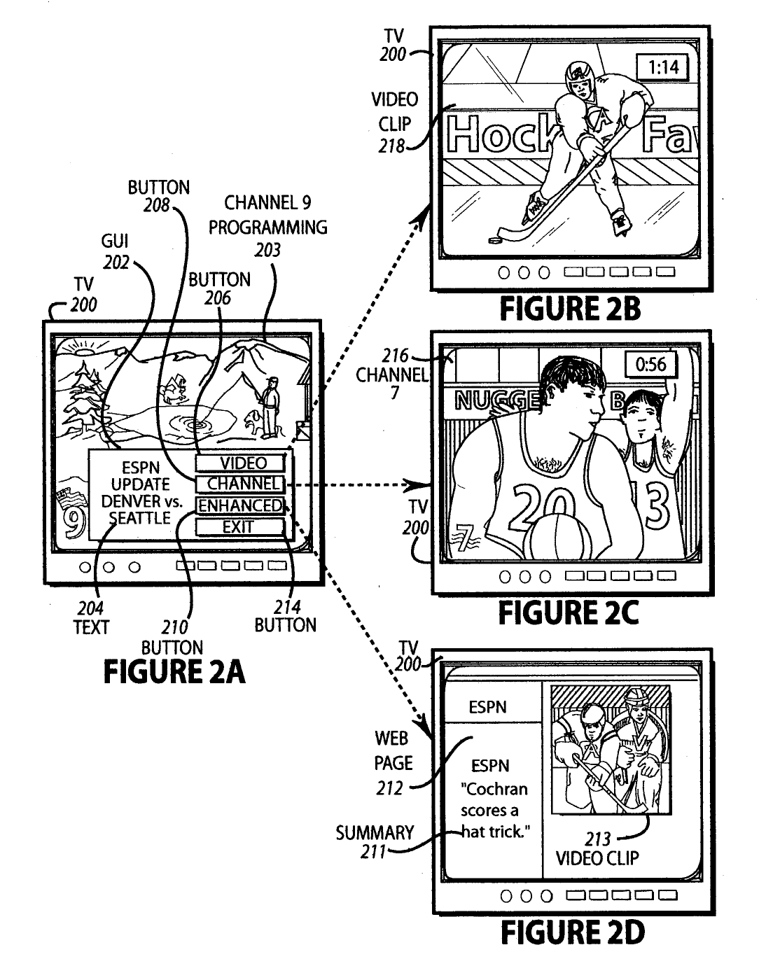

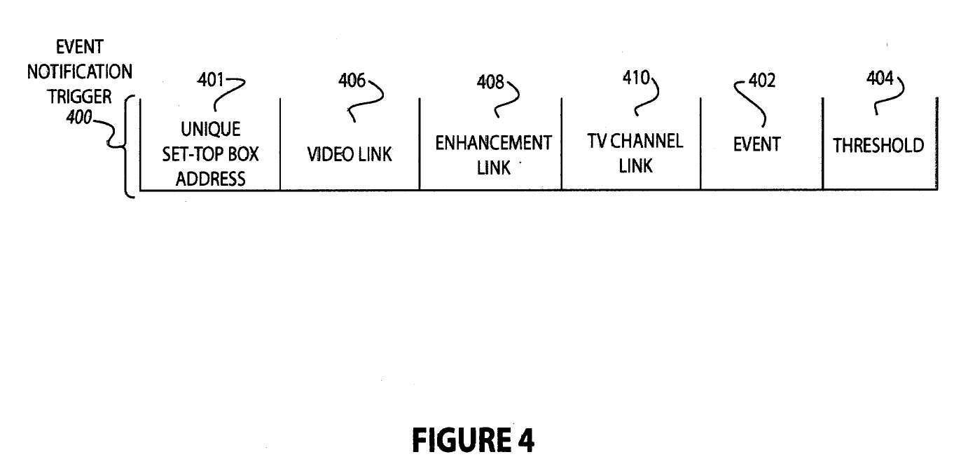

Turning again to FIG. 1, if a match is made between the stored event data 113, that is stored in event data database 112 and the stored user preferences 115, that are stored in user preferences database 114, then the event notification server 102 creates an event notification trigger (ENT) 141. The ENT 141 may comprise data, including the event that caused the trigger, the threshold that was met, and links including optional links. Optional links is further discussed with regard to the description of FIG. 2. Links may include a link to stored video 136, such as a video clip supplied by the content provider, a link to a web page, which may comprise an enhanced web page, and/or a link or switch to an alternate television channel. Once the ENT 141 is created by the ENS 102, the ENS 102 may send the ENT 141 to an event notification trigger inserter 190. The ENT 141 may be inserted into the regular broadcast 189 by the ENT inserter 190 in numerous ways. The ENT inserter 190 may directly encode regular broadcast 189 with ENT 141 to create encoded regular broadcast 191. The ENT-encoded regular broadcast 191 may then be sent to the basic cable server 124, and finally to the set-top box 118. The ENT 141 may therefore include a unique set-top box address that allows delivery of the ENT-encoded regular broadcast 191 to the correct set-top box 118. The unique set-top box address is further discussed with regard to the description of FIG. 4.

Another way in which ENT inserter 190 may encode regular broadcast 189 with ENT 141 is by sending ENT 141 to DMUX/MUX 192. A unique set top box address is sent, along with ENT 141, from ENT inserter 190 to DMUX/MUX 192. The ENT 141 may be sent from the ENT inserter 190 to the DMUX/MUX 192 over connection 194, which may comprise a network connection, Ethernet connection, or other connection. MUX 192 combines ENT 141 with the regular cable broadcast 189 and sends the encoded regular broadcast over cable 122 to set-top box 118. In this way, the ENT 141 is sent directly to a specific set-top box 118 without requiring a unique set-top box address embedded directly within the ENT 141.

Looking again to FIG. 1, the event notification trigger (ENT) 141 may appear to the user 126 on the user's television set 120 in the form of a graphical user interface (GUI). This GUI is further discussed with regard to the description of FIG. 2. The GUI may present options to the user 126. Again, the options presented by the GUI may include links. For example, links may include a link to stored event video 136 that is stored on event video storage device 116, a link to an existing web page, which may be an enhanced television-specific web page, and/or a link or switch to an alternate television channel. If the user chooses to view a stored event or video clip 136, the set top box 118 may access the stored video clip 136 from the event video storage device 116 associated with video server 108. Stored event video clip 136 may be continuously repeated for a certain time, i.e., carouselled or replayed a selected number of times, by event video storage device 116.

The event notification trigger (ENT) 141 may include one or all of the above-mentioned options, depending upon what links are supplied to the ENS 102 by the content provider 100. The user 126 may then specify which option the user 126 wishes to activate. For example, if the content provider 100 provides a weather event, the user 126 may have the option of viewing an optional link regarding that weather event, which may indicate the areas of the warning, what type of warning it is, road conditions, and so on. If no video is associated with the weather event, then the user 126 may simply click on audio, textual or graphical information regarding the weather event. As another example, if an event comprises a winning shot in a basketball game, that event may be stored as a stored event video clip 136 in the event video storage device 116. If an event notification trigger (ENT) 141 includes a link to event video clip 136 displaying the winning shot, and if the user 126 selects the link to the event video clip 136, the set top box 118 may download the event video clip 136. The stored event video clip 136 will then be sent from the event video storage device 116 to the basic cable server 124. The stored video clip 136 is thereby transmitted from the video storage device 116 to the set-top box 118. Event video 104 may comprise streaming (real-time) video, broadcast video, stored video, on-demand video, MPEG video that may not be broadcast but may be stored as broadcast quality, or other types of video. Alternatively, the user 126 may switch to another regularly broadcast channel. A link to another regularly broadcast channel, as contained in the ENT 141, may comprise an instruction to the set top box 118 to change the channel to another channel, such as the weather channel, etc.

As another option, the user 126 may establish an asymetric connection to the Internet 140 via an Internet Service Provider (ISP) 142. The ISP 142 may be accessed by the set top box 118 via a high speed network connection 144 or any desired type of connection. ENT 141 may include a link to a website 140 that is accessed by the user 126 through ISP 142. The website 140 may contain event video or event data that relates to the event information.

Updated video clips supplied by the content provider 100 may comprise sports video clips. For example, a football video clip may include replay data such as the last four of the most important plays in the football game depending on what kind of threshold the user 126 has entered into the set-top box 118. The set-top box 118 may include a clock which controls periodic updates of user preferences 131, such as checking user preferences every 30 seconds or every minute. For example, the user 126 may enter user preferences 131 upon turning on the user television 120 and at any time thereafter while watching the user's television set 120. Upon turning off the television 120, the set-top box 118 may send a notification to the event notification server 102 that the user 126 is now off line. Every user 126 will have different thresholds and different user preferences 131 that are specific to that user's set-top box 118. The event notification server 102 may send the appropriate event notification trigger 141 to the set-top box 118 according to the set-top box's specific unique individual address as described with regard to the description of FIG. 4.

FIGS. 2A, 2B, 2C and 2D are graphical illustrations of the display of event information, including event data and event video. As shown in FIG. 2A, a display device such as television set 200, displays a graphical user interface (GUI) 202. GUI 202 provides a notification to the user that one or more thresholds have been satisfied of the user preferences 131, i.e., that an event has occurred. For example, the user may have requested, as one or the user preferences, to be notified whenever a change of score of 5 points or more occurs in the Denver-Seattle football game during the broadcast of the game on channel 7, as illustrated by reference numeral 216, FIG. 2C. At the same time, the user may be viewing an episode of “Wild Kingdom” on channel 9, as illustrated by reference numeral 203, in FIG. 2A. During the viewing of channel 9, as illustrated by reference numeral 203 in FIG. 2A, a change of score in the Denver-Seattle football game of greater than five points may occur. The user may then be shown GUI 202, which comprises the event notification trigger, as previously described with respect to the description of FIG. 1. GUI 202 may comprise text 204 “ESPN update Denver vs. Seattle,” and may present the user with several options.

Referring to FIG. 2A, the GUI 202 may comprise a “video” button 206 which may, upon activation by the user, allow the user to view a video clip 218 of the recent scoring events as shown in FIG. 2B. The set-top box tunes into an event video storage device 108, retrieve the carouselled video clip 136, and displays the video clip 136 on the display device 200, as shown in FIG. 2B.

Referring again to FIG. 2A, the GUI 202 may further include a “channel” button 208, which, upon activation, allows the user to view the current Denver-Seattle game. Upon activation of the channel button 208, the set-top box switches from the current channel 9, as illustrated by reference numeral 203 of FIG. 28, to channel 7, as illustrated as reference numeral 216 of FIG. 2C, to watch the current game. Alternatively, the set-top box may switch to any other available channel as provided by the basic cable company, such as the Weather Channel. Alternate channels may broadcast as live or pre-recorded broadcasts.

Referring again to FIG. 2A, the GUI 202 may also include an “enhanced” button 210, which, upon activation, accesses a web page 212, as shown in FIG. 2D. The web page 212 may comprise an enhanced web page. This enhanced web page may appear to the user as a small portion overlaying the current channel being broadcast. Alternatively, the web page 212 may occupy the entire screen of the television set 200. The enhanced web page 212 may comprise a web page designed specifically for television and, from the user's perspective, appear as a regular television viewing experience, comprising large font and high-quality graphics. As shown in FIG. 2D, the enhanced web page 212 may include enhanced content, such as a textual summary 211 of the recent score change in a hockey game, accompanied by a small video clip 213 showing the play that brought about the change in score. The enhanced web page may retrieve information from the Internet. This information is provided to the set-top box 110 through an Internet Service Provider (ISP) 142 via a high-speed connection 144, as previously discussed with regard to the description of FIG. 1. The video clip 213 may be provided by a content provider such as ESPN. Alternatively, the web page 212 may comprise an existing web page that is not television-specific, and that includes the same data feed that may be received by a personal computer.

Referring again to FIG. 2A, GUI 202 may further comprise an “exit” button 214, which may allow the user to return to the original broadcast, “Wild Kingdom” 203, as shown in FIG. 2A, upon activation of the “exit” button 214. Of course, the options provided by GUI 202 may appear, upon activation, as full-screen configurations, partial screen configurations, or other display configurations on the television set 200.

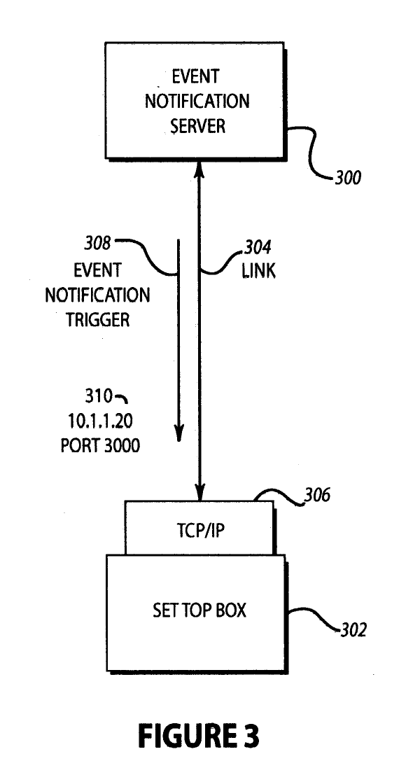

FIG. 3 is a block diagram illustrating access of a set-top box by an event notification server. As shown in FIG. 3, an event notification server (ENS) 300 may access a set-top box 302 via link 304. The set-top box 302 may have a unique identification address 306 associated with the set-top box 302. The identification address 306 may comprise a TCP port, an IP address or other identifying addresses. In addition, the set-top box 302 may receive an event notification trigger 308, which may comprise video and/or event data. As discussed with regard to the description of FIG. 2, the event notification trigger 308 may comprise a block of data which may comprise a unique set-top box address, an event, a value/threshold, an optional stored video link, an optional enhancement link, an optional live television channel, or other data. The event notification trigger 308 may be identified by a unique identifier 310. Again, a unique identifier 310 may comprise a TCP port, an IP address or other port or address. The IP address 306 on the set-top box 302 may accompany user preferences that are input into the set-top box 302, when the user preferences are sent from the set-top box 302 to the event notification server 300. In this way, the event notification server 300 may distinguish between each individual set-top box involved in the overall system. Upon creating an event notification trigger 308, the ENS 300 may send the event notification trigger 308 to the correct set-top box 302 by using the unique identification address 306 for each set-top box. The event notification trigger 308 is further described with respect to the description of FIG. 4.

FIG. 4 is a graphical representation of one embodiment of an event notification trigger. The event notification trigger (ENT) 400 may comprise a “block” of data as schematically illustrated in FIG. 4. The ENT 400 may comprise an event 402 and threshold 404 (previously input by the user) that was exceeded. The ENT 400 may further comprise a link 406 to stored video. As before, the stored video may reside in an event video storage device on a video server. The ENT 400 may further comprise a link 408 to an enhancement. By activating the enhancement link 408, the user may access a web page, which may be an enhanced web page. The ENT 400 may also comprise a link 410 to a television channel. As previously mentioned with regard to the description of FIG. 1, an ENT inserter 190 may directly encode the video stream with ENT 141/400. The ENT 141 must therefore comprise a unique set-top box address 401. The unique set-top box address 401 may distinguish which set-top box will receive the ENT 141. Of course, trigger 400 may comprise any or all of the examples given in the description of FIG. 4, depending on the content provided by the content provider.

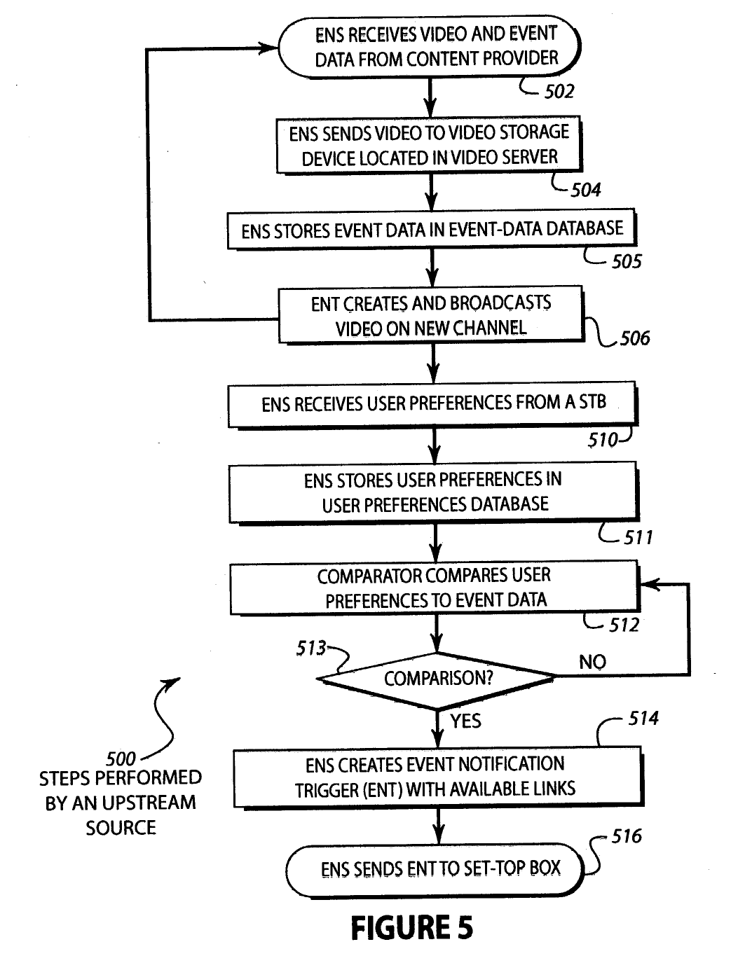

FIG. 5 is a flow diagram illustrating the steps 500 performed by an upstream source, such as a head-end, in carrying out an implementation of the present invention. Referring to FIG. 5, an event notification server (ENS), located at a head-end, may receive video from a content provider in step 502. As discussed above with regard to the description of FIG. 1, the content provider may comprise any content provider capable of sending content to viewers. The content provider may comprise a television network, television studio, a live broadcast, an Applications Service Provider, an Internet Service Provider, or other content provider. Television networks may comprise ESPN, FOX, MSNBC, the Weather Channel, or other networks providing sports, news, weather, and other information. The content provider may provide the ENS with a live broadcast such as a weather channel, sports channel, etc., or a pre-recorded video segment. Along with video information, the content provider may also send event data to the ENS in step 502. The event data may comprise textual information to accompany video input. Textual information may comprise real-time stock numbers, sports scores, current weather updates, current breaking-news headlines, or other information. The ENS may associate or link the event data to corresponding video. Updated video information and event data may be continuously supplied to the ENS from the content provider.

Referring again to FIG. 5, the ENS may be coupled to a event video server 108. The event video server 108 may contain an event video storage device. The event video storage device may comprise a computer hard drive, a video on-demand system which may store video segments, or other type of event video storage device. The process then proceeds to step 504, where the ENS 102 may send the video to the event video storage device located within the event video server 108. The event video storage device may then store the live video segments stored video, which may comprise video clips or video hi-lights. The process then proceeds to step 505 where the ENS may store the event data in an event data database.

Looking again to FIG. 5, the process then proceeds to step 506 where the ENS may create and broadcast the stored video, located on event video storage device, on a new channel. The new channel may be dedicated to a specific stored video clip and may play the stored video clip repeatedly (carousel the video clip) until the video clip is updated by a newer video clip from the content provider. The event information may also be multicast as interactive content, such as disclosed in U.S. Non-provisional patent application Ser. No. 10/383,270, entitled “MULTICASTING OF INTERACTIVE DATA OVER A BACK CHANNEL,” filed Mar. 5, 2003 by Ian Zenoni, which is specifically incorporated herein by reference, for all that it discloses and teaches. The process then proceeds to step 510 where the ENS may receive user preferences from a set-top box. As discussed with regard to the description of FIG. 4, the set-top box may have an identifier address associated with the set-top box to distinguish the set-top box from other set-top boxes accessing the ENS. The identifier address may be encoded within the set-top box. The user preferences may be input by a user into the set-top box. The user preferences may comprise video and/or data events in which the user may be interested, such as stock updates, sports scores, weather updates, breaking news or other information. The user may also specify thresholds (the limits/circumstances which define events). For example, the user may specify to be notified upon any change in a sports score that has occurred within the last five minutes, or the user may wish to view the user's favorite stocks each time the user's favorite stocks fluctuate by plus or minus $5 per stock. Alternatively, the user may wish to be notified upon a serious change in the weather, or a change in score of a football game. The user may select preferences in more detail. For example, the user may wish to see an update of the football score every time a field goal or touchdown is scored. Once a threshold is met, the ENS may display a graphical user interface (GUI) to the user that provides the user the option of viewing the event in more detail. The GUI may appear on the user's display device which may comprise a television.

Turning again to FIG. 5, the process proceeds to step 511 where the ENS may store the user preferences in a user preferences database. The process then proceeds to step 512 where the stored event data, located in the event data database, may be compared with the stored user preferences, located in the user preferences database. The process may then proceed to step 512, where a comparison may be made, by a comparator coupled to the ENS, between the stored user preferences and the stored event data. The process continues to step 513, where a query is made as to if a successful comparison has occurred between the stored user preferences and stored event data. If a comparison is not made between the stored user preferences and the stored event data, the process returns to step 512 where the comparator may continue to compare stored user preferences to stored event data. If a successful comparison is made between the stored user preferences and stored event data, then the process proceeds to step 514 where the ENS may create an event notification trigger (ENT). As discussed with regard to the description of FIG. 4, the ENT may comprise a unique set-top box address, a link to stored video, a link to an enhancement which may comprise a web site, a link to a separate television channel, an event, and the thresholds. The process then proceeds to step 516 where the ENS may send the ENT to a single, unique set-top box, where again, the ENT may appear to the user in the form of a GUI on the user's television set.

As previously mentioned with regard to the description of FIG. 1, an ENT inserter may directly encode the video stream with ENT before the video is sent from the ENS to the set-top box. Alternatively, a de-multiplexer/multiplexer (DMUX/MUX) may insert the regular broadcast video with the ENT before sending the video to the set-top box.

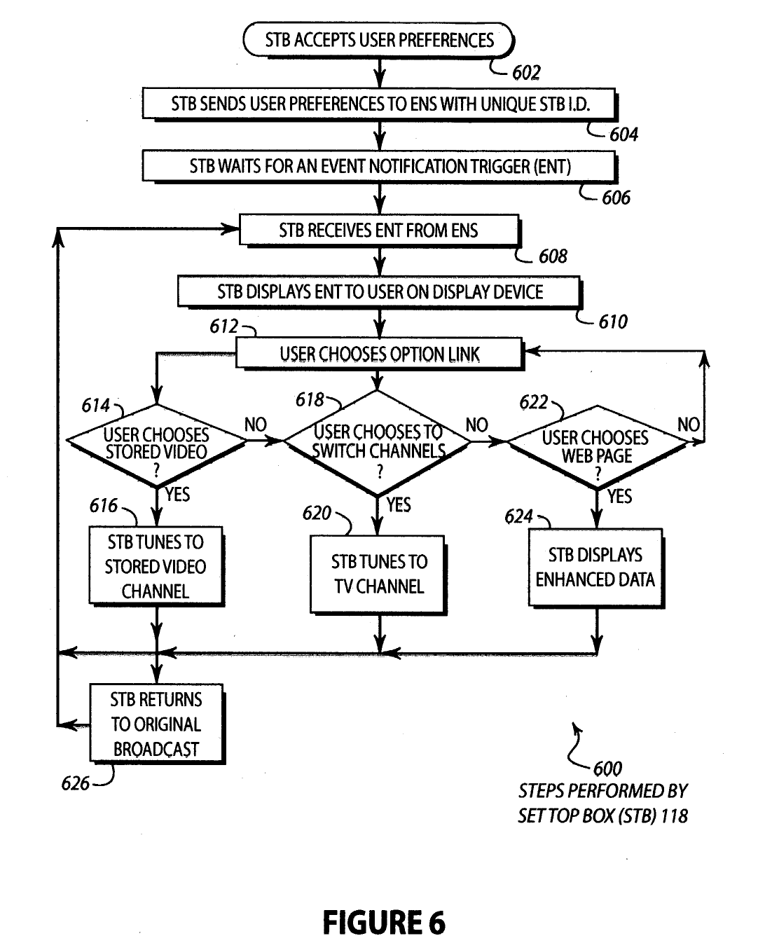

FIG. 6 is a flow diagram illustrating the steps 600 performed by the set-top box in carrying out an implementation of the present invention. At step 602, the set-top box may receive user preferences entered by the user. As before, user preferences may comprise events the user wishes to see, threshold values used to activate the creation of triggers, etc. The user may update the user's preferences at any time during the interaction between the user and the present invention. The process then proceeds to step 604 where the set-top box may send the user preferences to the event notification server (ENS) along with a unique set-top box identification address.

Referring to FIG. 6, the process then proceeds to step 606 where the set-top box may wait to receive an event notification trigger (ENT) from the ENS. Upon creation of the ENT by the ENS, the ENT may be sent from the ENS to the set-top box. The set-top box tunes into a specific channel on an event video storage device in response to the ENT. The set-top box receives video via that channel, which again may repeat continuously on a carousel until the video clip is updated by a new video clip from the content provider. At step 608, the set-top box may receive an ENT from the event notification server. At step 610, the set-top box may display the event notification trigger (ENT) to the user. The event notification trigger may be displayed in the form of a graphical user interface (GUI) on a display device. The display device may comprise a television set, a remote control, a web tablet, or other display device. The location in which the display is shown may be selected by the user. At step 612, the user may choose an optional link provided by the ENT. The user may select an option as indicated by the GUI.

Looking again to FIG. 6, at step 614 a query is made as to if the user would like to view stored video. If the user selects the option of viewing stored video, then the process proceeds to step 616 where the set-top box tunes in to a stored video channel. The stored video may be stored in event video storage device 116 located within event video server 108. The process then proceeds to step 626 where the set-top box may return to the original broadcast. The set-top box 118 may display the original broadcast until another event notification trigger 141 is sent to the set-top box from the event notification server 102.

Turning again to FIG. 6, the process proceeds to step 618. If the user selects the option of viewing a television channel, then the process proceeds to step 620 where the set-top box may tune in to a television channel. The television channel may comprise a weather channel, a sports channel, a news channel or other channel. The process then returns to step 606 where the set-top box 118 waits for an ENT 141. If the user 126 does not select the option of viewing a television channel, then the process proceeds to step 622. If the user selects the option to view an enhancement, then the process proceeds to step 624 where the set-top box may display enhanced information. Enhanced information may comprise web pages and streaming video. Again, this enhanced information may be multicast as disclosed in U.S. Non-provisional patent application Ser. No. 10/383,270, entitled “MULTICASTING OF INTERACTIVE DATA OVER A BACK CHANNEL,” filed Mar. 5, 2003 by Ian Zenoni, which is specifically incorporated herein by reference, for all that it discloses and teaches. The process then returns to step 606 where the set-top box waits for an ENT.

FIG. 7 is a flow diagram illustrating the steps 700 performed by the content provider 100 in sending trigger information to the event notification server (ENS) 102. The content provider “initializes” the ENS 102 at step 702. The content provider notifies the ENS 102 of the type of content that the content provider 100 will send to the ENS 102. The content sent by the content provider 100 may comprise one or more of the following: a unique set-top box address, a value or threshold, an event, a television channel link, an enhancement link such as a web address, and a link to stored video. At step 704, if event video 104 is available from the content provider 100, the content provider 100 sends event video 104 to the ENS 102. The process then proceeds to step 706 where the content provider 100 begins sending event information to the ENS 102. At step 708, the content provider 100 updates the ENS 102 when video clips or web addresses are updated. The ENS 102 may assign an address to the event video 104 and event data 106. As before, the ENS 102 then compares the event video 104 and event data 106 with user preferences received from the set top box 118.

The present invention therefore provides a system and method that allows notifications to be displayed to a user on an interactive television. The present invention provides visual information on recent events, including video clips, web pages, and enhanced web pages. The present invention provides access, through the Internet, to enhanced web pages designed specifically for television, and regular web pages. The present invention allows the user to switch from the current broadcast to another channel, such as the channel displaying the recent event.

What is claimed is:

1. A method of providing event information to a user on a television comprising:
receiving event information, including event data and event video, at an event notification server located at an upstream source, said event information generated by a content provider;
transmitting said event data to an event data database for storage and retrieval of said event data;
transmitting said event video to event video storage for storage and retrieval of said event video;
receiving user preferences from a set-top box at said event notification server via an upstream connection between said set-top box and said event notification server;
transmitting said user preferences to a user preference database for storage and retrieval of said user preferences;
comparing said event data with said user preferences at said event notification server;
generating an event notification trigger upon favorable comparison of said user preferences and said event data, said event notification trigger including an address of said set-top box;
transmitting said event notification trigger to said address of said set-top box;
generating a graphic user interface on said television, using said set-top box, in response to said event notification trigger, said graphic user interface allowing said user to select at least one of: downloading said event video from said event video storage for display on said television; accessing an Internet location that provides said event information on said television; switching said television to an alternate channel that is displaying said event information, and exiting said graphic user interface.

2. The method of claim 1 wherein said step of accessing an Internet location comprises:
providing a link to a web page.

3. The method of claim 1 wherein said step of accessing an Internet location comprises:
providing a link to an enhanced web page.

4. The method of claim 1 wherein said step of receiving user preferences from a set-top box at said event notification server via an upstream connection comprises:
receiving said user preferences from said set-top box at said event notification server via a back channel.

5. A system for providing event driven notifications to a user and displaying event information on a television comprising:
an event notification server, located at an upstream source, that receives event video and event data from said content provider;
an event video storage device that receives said event video from said event notification server and that stores said video associated with said event data;
an event data database that receives said event data from said event notification server and that stores said event data;
a user preference database that receives preferences from said user and stores said preferences;
a comparator that compares user preferences to said event data, and that generates an event notification trigger having an address for transmitting said event notification trigger to said user;
an event notification trigger inserter that inserts said event notification trigger into a television transmission signal that is transmitted through a downstream connection to said user;
a set-top box that receives preferences provided by said user and transmits said preferences through an upstream connection to said user preference database, and that receives said event notification trigger from said event notification server via said downstream connection and generates a graphic user interface for display on said television that allows said user to select at least one of: downloading said event video for display from said event video storage device through said downstream connection; accessing an Internet location that provides said event information; switching to an alternate channel displaying said event information; and, exiting said graphic user interface.

6. The system of claim 5 wherein said downstream connection is a cable connection and said upstream connection is a back channel on said cable connection.

7. The system of claim 5 wherein said downstream connection is a satellite connection and said upstream connection is a back channel on said satellite connection.
